(19) United States
(12) Patent Application Publication
(10) Pub. No.: US 2008/0100012 A1
(43) Pub. Date: May 1, 2008

(54) BALE CARRIER

(76) Inventor: Rasmussen J. Randall, Ellensburg, WA (US)

Correspondence Address: MERCHANT & GOULD PC, P.O. BOX 2903, MINNEAPOLIS, MN, 55402-0903, US

(21) Appl. No.: 11/857,996

(22) Filed: Sep. 19, 2007

Related U.S. Application Data
(60) Provisional application No. 60/826,331, filed on Sep. 20, 2006.

(51) Int. Cl. B62B 1/14

(52) U.S. Cl. 280/47.24

(57) ABSTRACT

A hand-operated carrier is provided for lifting and transporting heavy bales of plant material, such as bales of hay or other objects, which is structured to enable persons of even modest strength to lift and transport such bales of material. Tie carrier provides bale engaging members associated with a rigid frame and a wheel assembly so that the device engages and lifts the bale, thereby avoiding the need to physically lift the bale for transportation.

### TECHNICAL FIELD

This invention relates to farming implements, and more specifically relate to a hand-operated device for easily lifting and moving a hay bale or other similar object with a minimum of physical strain or exertion.

### BACKGROUND ART

Various types of alfalfa, clover, grains, grasses and other plant materials grown under agricultural cultivation are cut and baled out in the field. For many years, farm hands would physically lift the bales of plant material in the fields and place them in a cart, wagon or truck for transport off the field. Once the bales were delivered off the field, farm hands would remove the bales from the transport means and physically move the bales to other areas for storage, or for transport to market. In the last century, large farming equipment has been developed to pick up bales of hay and the like from the field for transport to a storage area or for sale on the market. Despite the development of large bale-moving equipment, there are still many occasions when it is impractical or impossible to move bales of plant material using large equipment, either because the few number of bales that need to be moved did not warrant using large equipment or the place where the bales are located will not accommodate a large truck or other devices. In such instances, the bales must be moved by hand. Moving bales of material by hand is not only physically exhausting but can only be done by persons possessing significant strength.

Recognizing that there are occasions when bales of plant material must be moved by hand, various implements have been used to carry out the task. Principally, conventional hand carts or wheelbarrows have been used to move bales of plant material. Other devices have been specifically developed for use in carrying a bale of plant material, but such devices usually comprise the same elements as in handcarts or wheelbarrows. As a result, the task of moving heavy bales of plant material is still a strenuous job, which can only be undertaken by persons possessing significant strength. Therefore, known hand-operated bale transport devices cannot, therefore, be used by smaller children or adults with reduced strength capabilities.

For instance, U.S. Pat. No. 2,814,402, issued to Schaefer, discloses a device that uses tines and a hand cart design. However, use of this device would require significant strength. A user would need significant strength to engage the tines (Element 51 in FIG. 2, Column 4, Lines 41-42) in or under a bale of hay. Moreover, once, the tines are secured the bale of hay, a user would need significant strength to force the device onto its wheels.

U.S. Pat. No. 6,050,577, issue to Smith, discloses elongated tines that can be set in either upward or downward configurations to hold bales (1^{st} feature of claim 1; 30 in FIGS. 3-4). However, like the patent above, it also requires significant strength to operate. Specifically, significant strength must be exerted to force the tines into a bale. Moreover, once the tines are engaged under the bale, significant strength must be used to force the cart on its two wheels.

U.S. Pat. No. 6,478,526, issued to Agee, discloses a wheel assembly and arms with bale spikes (Elements 60, 60 in FIG. 1; Column 3, Lines 18-29; Claim 1; Lines 29-30; Claim 10). Again, like previous attempts at designing bale carriers, significant strength is required to operate the device. Specifically, significant strength must be use to engage the tines in the bale. Moreover, once the tines are engaged, the user must lift and balance the entire bale on only a single wheel.

U.S. Pat. No. 6,364,596, issued to Spencer, discloses a hand cart adapted to transport a single bale of hay. Yet again, like previous attempts at designing bale carriers, significant strength is required to operate the device. Specifically, once the tines are engaged in the bale, significant strength must be used to force the cart on its two wheels.

Thus, it would be advantageous to provide a hand-operated carrier for enabling an individual of even modest strength to easily engage and lift a heavy bale of plant material without causing undue strain.

### SUMMARY OF THE INVENTION

In accordance with the present invention, a carrier for lifting and transporting bales is provided, which is structured to be easily hand-operated and maneuverable to engage and transport bales of plant material, or similar objects, minimizing effort needed to physically lift the object to engage it with the carrier. The configuration and construction of the present invention is such that persons of even modest strength can engage heavy bale-like objects and transport them a considerable distance.

The carrier of the present invention generally comprises a pair of bale engaging members moveable mounted upon a rigid frame, which is attached to a wheel assembly. The wheel assembly comprises a pair of wheels designed to be placed adjacent opposing sides of a bale at its center. The rigid frame extends upwardly from each wheel and across the top of the carrier, so that the carrier may be placed over a bale with the wheels positioned beside the bale. The bale engaging members are brought into engagement with a bale of hay by movement of the handle, which is pivotally connected to the frame and also operatively attached to the bale engaging members. Once the device has been maneuvered into place over the bale of hay, the handle is rotated upwardly, pressing the bale engaging members against the bale, and simultaneously raising the bale engaging member, which grips and lifts the bale of hay upwardly from the ground. The device carrying the bale may then be transported manually to a desired location, balanced on the wheels. Once the bale of hay has been delivered to its intended destination, the handle is rotated to its starting position, which lowers the bale to the ground and disengages the bale engaging members from the bale. The carrier is then pushed away from the bale of hay.

### BRIEF DESCRIPTION OF DRAWINGS

The present invention, both as to its organization and manner of operation, together with further objects and advantages, may best be understood by reference to the following descriptions, taken in conjunction with the accompanying drawings, wherein:

FIG. 1 is a perspective view showing the carrier constructed in accordance with a preferred embodiment of the invention.

FIG. 2 is an enlarged perspective view of the gripping mechanism just before the mechanism begins to grip a bale.

FIG. 3 is an enlarged perspective view of the gripping mechanism as it grips the bale, and lifts it up.

FIG. 4 is an enlarged perspective view of the spring-loaded rod mechanism attached to the handle and frame.

FIG. 5 is a view of the carrier being positioned on the bale.

FIG. 6 is a view of the carrier in position to grip the bale.

FIG. 7 is a view of the gripping mechanism halfway engaged.

FIG. 8 is a view of the gripping mechanism almost fully engaged in which the bale is being lifted off the ground.

FIG. 9 is a view of the gripping mechanism fully engaged.

### DISCLOSURE OF THE INVENTION

Referring now to the drawings, the invention will be described in a preferred embodiment by reference to the numerals of the drawing figures wherein like numbers indicate like parts.

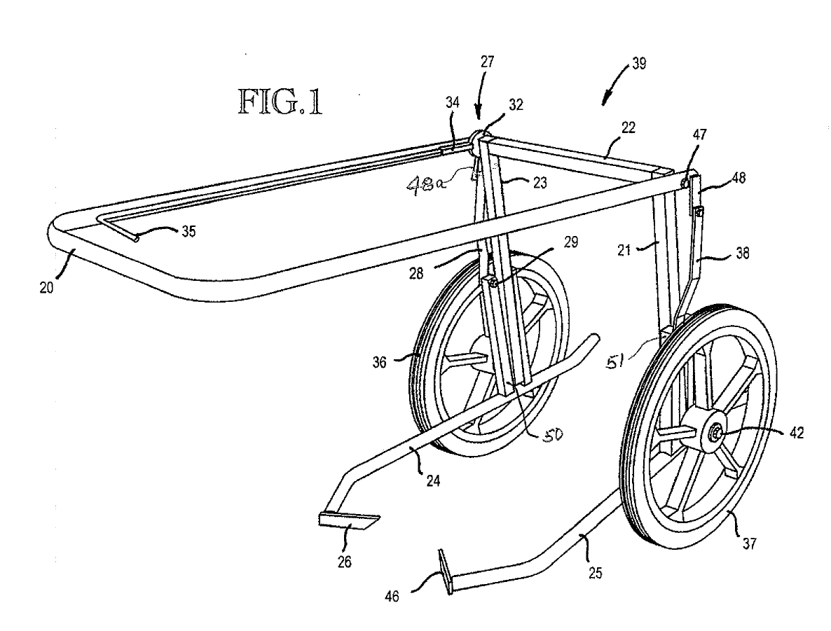

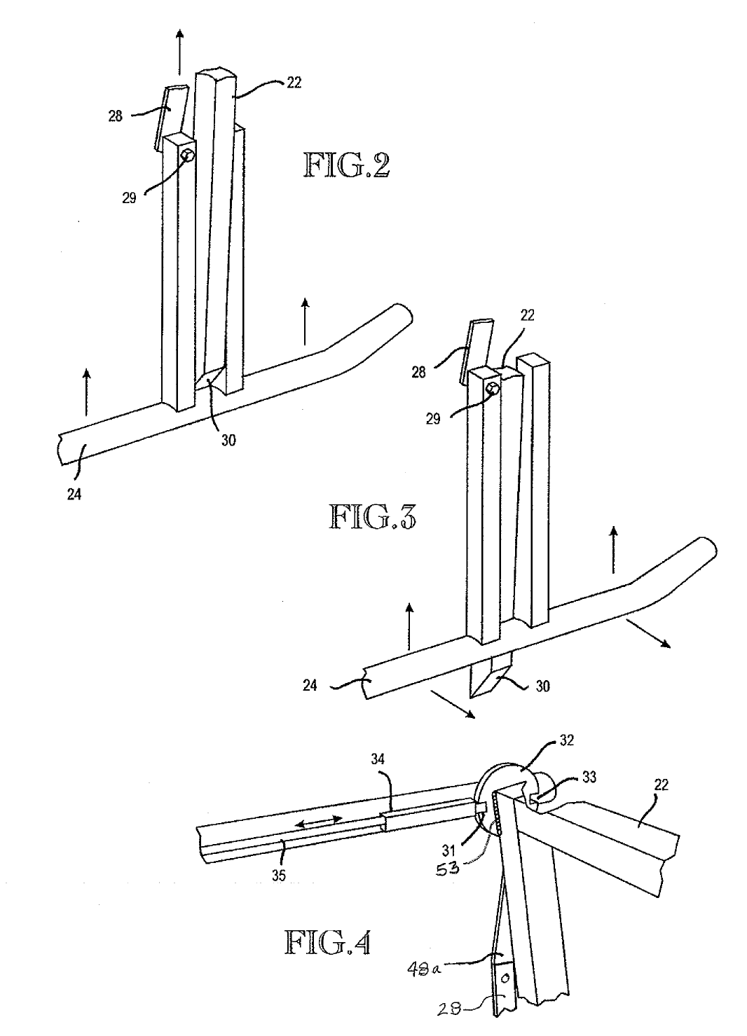

Referring to FIG. 1, there is shown a carrier 397 which employs lever principles to grip and lift a bale, thereby alleviating the lifting forces necessary to lift and transport a bale. FIGS. 2, 3 and 4 illustrate the mechanisms used to grip, lift and lock the bale in place. FIGS. 5, 6, 7, 8 and 9 show the operation of the carrier on a bale.

As is best seen in FIG. 1, lifting and gripping of a bale is done by placing carrier 39 over a bale and rotating handle 20. The exact shape and size of frame elements 21, 22, and 23 and handle 20 can be modified as necessary to meet the dimensions of the bale. Handle 20 is attached to frame 22 by pivots 27 and 47. Pivot arms 48 and 48a are attached to handle 20 by a weld or similar attachment method. Links 28 and 38 are attached at proximal ends to pivot arms 48 and 48a and at their distal end to uprights 50 and 51 which are in turn rigidly connected to bale engaging members 24 and 25. Bale engaging members 24 and 25 contact vertical elements 21 and 23 of U-shaped frame 22 on the front and back sides of frame 22 and engage beveled surfaces 30. This stabilizes the movement of bale engaging members 24 and 25 and causes members 24 and 25 to move inwardly when raised. Bale engaging members 24 and 25 have prongs 26 and 46 extending to pierce the bale. Prongs 26 and 46 pierce the bale and help stabilize the bale during transport. Frame 22 has wheels 36 and 37 attached one on each side thereof to transport of the bale 40 suspended in carrier 39. The wheel size can be modified as necessary. Prongs 26 can pierce into the bale as carrier 38 is wheeled into position and easily pushed into the bale.

FIG. 4 shows Frame 22 having disc 32 attached at one upper corner thereof. Attachment can be a weld 53 or similar method. Disc 32 has open position disc detent 31 and closed position disc detent 33. These detents interact with latch 34 which is controlled by movement of rod 35. Latch 34 is carried by handle 20. Open position disc detent 31 serves to secure rod 35 in order to keep carrier 38 in position ready to accept bales. Closed position disc detent 33 is used to secure rod 35 in order to secure the bale when it is being carried.

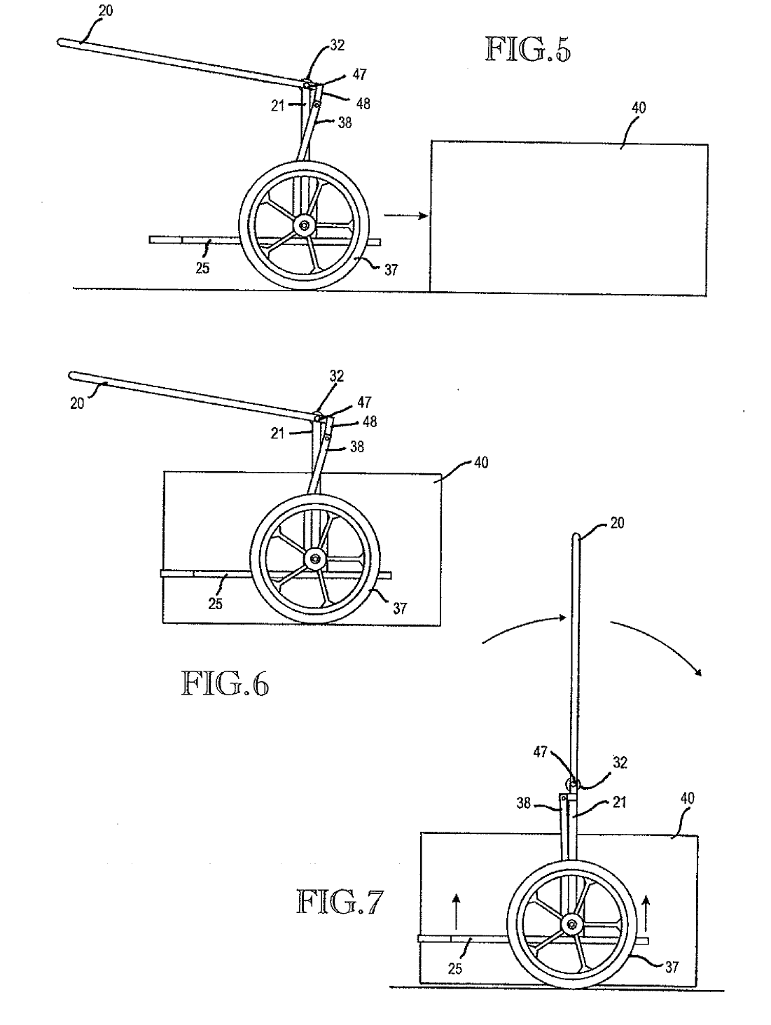

FIG. 3 shows bevel 30 and bale engaging member pivot 29. Bale engaging member pivot 29 secures link 28 to upright 50 extending upwardly from engaging member 24. As handle 20 is rotated upwardly, bale engaging member pivot 29 raises bale engaging member 24. As bale engaging member 24 is pulled up, it engages bevel 30. Bevel 30 serves to direct some of the force from handle 20 in a sideways motion of the bale engaging member 24 forcing it into contact with bale 40. The sideways motion is a result of bale engaging member 24 traversing bevel 30. Bale 40 is squeezed between the bale engaging members 24 and 25 The operation of carrier 38 is best seen with reference to FIG. 5-9. FIG. 5 illustrates carrier 39 being positioned relative to bale 40. Bale 40 is positioned in between the arms of frame 22 and between bale engaging members 24 and 25 as illustrated in FIG. 6. In the preferred embodiment, latch 34 is disengaged from detent 31 and handle 20 is rotated with respect to frame 21 and bale engaging members 25 in an upward and circular movement as in FIG. 7.

The latch 34 is illustrated in FIG. 4. It is designed to lock handle 20 in one of two positions. The latch 34 fits into detents 31 or 33 in disc 32. Disc 32 is welded onto frame 22. The handle 20 may thus be locked in the open or closed position.

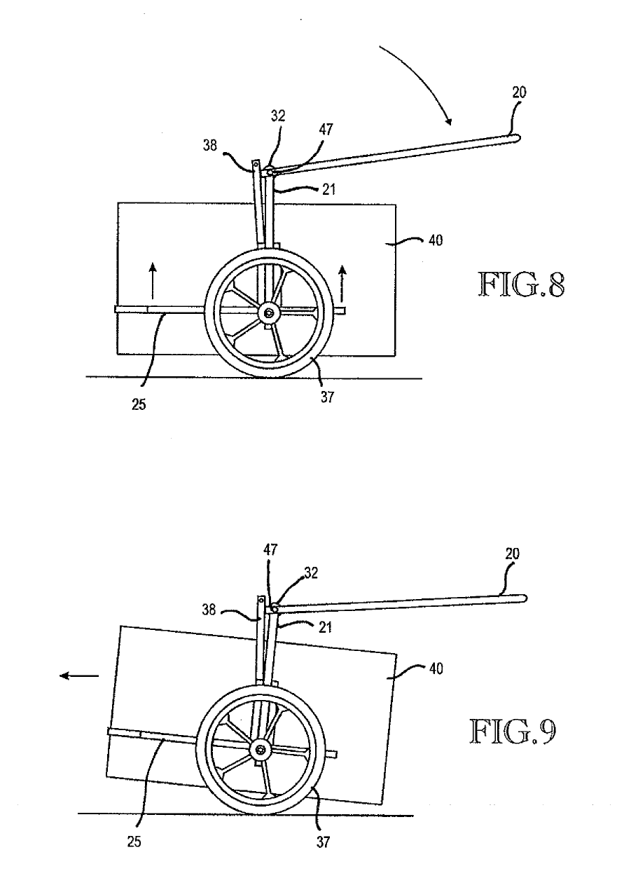

After latch 34 is disengaged from detent 31 and the handle is rotated upwardly on pivot 27 and pivot links arms 48 and 48a are rotated upwardly as seen in FIGS. 6 and 7. As pivot links 48 and 48a are pulled upwardly, gripping members 24 and 25 engage bevels 30. Bevels 30 induce a sideways motion on bale gripping members 24 and 25 forcing them together. The sideways motion urge bale gripping members 24 and 25 into gripping contact with the bale 40. The combined effect of these actions on both sides of frame 22 on bale 40 is that bale 40 is gripped with the sideways motion produced by bevels 30 and lifted upward as in FIG. 8. By well known principles of lever arms, the amount of lifting force required is substantially less than the force of gravity acting upon bale 40, Consequently, those persons physically incapable of lifting a bale without assistance can do so with carrier 39. The principles of levers used in this invention produce significant stress on carrier 38. Specifically, the stress on frame 22 is significant. Therefore, frame 22 must be made of rigid and strong material.

When handle 20 is fully rotated into the position shown in FIGS. 8 and 9, bale 40 is gripped and lifted and latch 34 will engage closed position disc detent 33 on disc 34. This will serve to lock the handle 20 in the transport position, which will in turn preserve the pressure and lift exerted on bale 40 via bale engaging members 24 and prongs 26.

Once the handle 20 is rotated fully into the transport position shown in FIGS. 8-9 with latch 34 engaged, bale 40 is securely gripped and elevated. Carrier 39 can now be pushed or pulled to transport the bale 40 with a minimum of force. Specifically, since wheels 36 are near the center of gravity of bale 40, very little force is required to balance carrier 39 on wheels 36. Moreover, there is no problem of having bale 40 potentially fall upon or injure the user as is presently true when one attempts to carry a bale of hay.

Discharge of bale 40 is accomplished by reversing the steps used to load bale 40. Latch 34 is released by pulling rod 35 and handle 20 is rotated upward in a circular motion. Motion of handle 20 moves pivot links 48 and 48a in such a way that bale engaging members 24 and 25 are lowered and permitted to move outwardly against bevel 30 away from bale 40. This lowers bale 40 and releases the grip produced by bale members 24 and 25. At the end of the circular motion of handle 20, the latch engages into disc 32 at open position disc detent 31 and carrier 39 is then locked in the open position, ready to be removed from the bale and moved to transport another bale.

While the principles of this invention have now been made clear in an illustrative embodiment, there will be immediately obvious to those skilled in the art many modifications of structure, arrangement, proportions, elements, materials and components, used in the practice of the invention which are particularly adapted for specific environments and operating requirements without departing from those principles.

### INDUSTRIAL APPLICABILITY

The industrial applicability of this carrier is to transport bales of hay or other objects from one location to another.

What is claimed:

1. A carrier for lifting and transporting a bale of compacted resilient material, said carrier comprising in combination:
a) a rigid U-shaped frame, having a substantially vertical side arms and a bridge connecting said side arms;
b) inwardly facing bevels at the lower end of each arm of said rigid frame;
c) a handle assembly pivotally connected to said rigid frame for rotation to and from a bale engaging position;
d) bale-engaging members slidably mounted adjacent said side arm and pivotally connected to said handle assembly said vertical side arm having bevelled engaging surfaces to force said bale engaging member into contact with said bale and simultaneously lift said bale from a support surface; and
e) a wheel rotatably attached to each side of said rigid frame;
whereby, a bale may be engaged and lifted by said carrier for transport.

2. The carrier of claim 1, wherein said bale engaging members are oriented substantially perpendicular to the side arms of said rigid frame.

3. The carrier of claim 1, wherein said rigid frame is oriented with the bridge between the two arms being the topside of the frame.

4. The carrier of claim 1, wherein said rigid frame has a disc at the pivotal connection of said handle with detents for receiving a lock to fix said handle in a raised or a lowered position.

5. The carrier of claim 1, wherein said handle has a spring loaded rod mechanism thereon to fasten said lock into said detents to secure the handle in a first raised position or a second lowered position.

6. The carrier of claim 1, wherein said bale engaging members have at least one prong oriented to engage one end of the bale of compacted resilient material.

7. The carrier of claim 1, wherein said wheels are positioned on said rigid frame so that when engaged upon a bale, the wheels are located approximately at the center of gravity of the compacted resilient material.

8. A method to for lifting and transporting a bale of compacted resilient material, the method comprising the steps of:
a) placing a bale transport mechanism over a bale, said mechanism having a frame configured to bridge over the top of said bale and having wheels positioned thereon to support said frame, said frame having bale engaging and lifting means operatively connected to a rotatable handle;
b) rotating said handle from a bale disengaged position to a bale engaged position which simultaneously lifts said bale into a transport position;
c) transporting said bale to the desired location;
d) rotating said handle from said bale engaged position to said bale disengaged position; and
e) removing said bale transport mechanism from said bale.

9. The method of claim 8 wherein said engaging member has at least one spike to penetrate the compacted resilient material and secure said resilient material in said transport position.

10. The method of claim 8 wherein said bale engaging and lifting means comprises a substantially horizontal rail positioned on each side of said bale transport mechanism to engage opposite sides of said bale and further comprising the step of;
simultaneously forcing said rails against said bale and raising said rails to lift said bale into transport position.
